(19) United States
(12) Patent Application Publication
(10) Pub. No.: US 2002/0184153 A1
(43) Pub. Date: Dec. 5, 2002

(54) System and method for sharing matched interests without disclosing non-shared interests

(76) Inventor: Jean Pierre De Vries, Kirkland, WA (US)

Correspondence Address: LYON & HARR, LLP, 300 ESPLANADE DRIVE, SUITE 800, OXNARD, CA, 93036, US

(21) Appl. No.: 09/681,790

(22) Filed: Jun. 5, 2001

(51) Int. Cl. G06F 17/60; H04K 1/00; H04L 9/00

(52) U.S. Cl. 705/50

(57) ABSTRACT

The present invention involves a new system and process for allowing automatic disclosure of at least one common interest between at least two entities while keeping non-common interests undisclosed or secret from other entities. Further, unlike conventional schemes for disclosing or sharing common interests, such disclosure or non-disclosure of interests is accomplished in accordance with the present invention without the use of a third party, mediation, or trusted agent type application or process for comparing shared or common interests. Consequently, in accordance with the present invention, there is no database, application, process, etc. that is external to any entity to which the interests of that entity is disclosed or revealed for the purposes of determining whether any of the entities interests match those of any other entity.

### BACKGROUND OF INVENTION

1. Technical Field

The invention is related to a system and method for automatically sharing matched or common interests between at least two entities while ensuring that non-shared interests are not disclosed or shared.

2. Related Art

By way of background, one conventional scheme for disclosing shared interests between at least two entities involves an electronic device that allows users to specify one or more particular interests from a limited set of predefined interests. The device then openly broadcasts these interests. Further, the electronic device also receives a broadcast from any other similar devices that are broadcasting such interests within a limited distance of the receiving device. Where an automatic comparison of the interests of the receiving device and the broadcasting device indicate that there is a shared or common interest, an audible and visible alert is provided by each device to indicate one or more potential matches within range of the electronic device. However, one problem with such devices is that the entire list of interests specified for a given device or user is broadcast such that it may be read or disclosed to anyone or anything capable of receiving the broadcast. Consequently, the device does not provide a capability for privacy, or non-disclosure of interests where there are no shared interests.

Other types of secure schemes have been developed to assist in determining whether two or more entities are either interested in each other, or have interests in common without disclosing those interests. For example, one conventional scheme uses a secure or trusted host to determine whether a specific member of a group of male participants is interested in a specific member of a group of female participants who is reciprocally interested in that specific male participant. In general, this system requires that each member of the male group disclose his encrypted interests to the trusted host. Similarly, each member of the female group discloses her encrypted interests to the trusted host. The trusted host then uses conventional cryptographic techniques to determine whether there is a match between specific male and female participants without decrypting the interests of any participants. Only where a match is identified, does the trusted host decrypt the interests to identify the matched participants. Specifically, each participant encrypts their interests, and sends this list of separately encrypted interests to the host, where they're compared. The comparison is accomplished without decryption by finding collisions in ElGamal ciphertexts using a conventional protocol for proving the equality or inequality of two discrete logarithms. The host then decrypts only those interests that actually match.

Consequently with the aforementioned scheme, the identities and interests of “losers,” or non-matched participants, are not revealed to anyone, including the trusted host. There are several important limitations to this scheme. For example, a trusted agent, host, or third party is required for matching interests. Consequently, in the absence of a trusted agent, host, or third party, the scheme is not operational. Further, this scheme requires participants to reveal their interests, even though encrypted. Consequently, there is a possibility that a participant's interests may become known either by a non-trustworthy or insecure host, or by unauthorized decryption of the participant's interests.

Another scheme addresses the problem of maintaining secrecy between mutually suspicious parties by providing a protocol for allowing users to verify whether they have matching credentials, identities, or interests without revealing their credentials, identities or interests to each other unless there is a match. However, while this scheme does not require a trusted third party or host at the time potential matches are made, this scheme does require a trusted third party or host at the time that users sign up for the system and enter their private information into the system. Specifically, the credentials, identities or interests of each entity are provided to the trusted host and encrypted by that host using an encryption key that is a hash of that information. Assuming that the hash function is publicly agreed on, the encrypted information will be the same for any user having the same information. Consequently, users can then simply search a database of encrypted credentials, identities, or interests without further need to use the trusted host in order to identify matches of that information. Consequently, this scheme, also suffers from the problem of requiring a trusted third party, at least initially, to function. Further, the encrypted credentials, identities, or interests are stored in a publicly accessible database. Thus, there is a possibility that a user's credentials, identities, or interests may become known either by a non-trustworthy or insecure third party or host at the time that information is first encrypted, or simply by unauthorized decryption of the participant's encrypted information.

Therefore, what is needed is a system and method for automatically sharing common interests between two or more entities without broadcasting or otherwise disclosing non-shared interests with other entities. Further, such a system and method should be capable of such sharing of interests without requiring the assistance or mediation of a third party or host. In other words, such a system and method should provide for direct peer-to-peer sharing of common interests without requiring a third party or host.

### SUMMARY OF INVENTION

The present invention involves a new system and process for automatically allowing at least two entities to disclose shared or common interests without disclosing non-shared interests. The present invention solves the aforementioned problems, as well as other problems that will become apparent from an understanding of the following description by automatically determining matched interests between two or more entities and disclosing those matches without disclosing non-matched interests. Further, such matching is accomplished without the use of an intermediary application, scheme, or process in order to avoid the disclosure of the interests of any entity to a third party. Specifically, interests are matched by automatically progressively comparing the interests of each entity. In accordance with the present invention, the term “entity” is defined to mean individual users, individual computer systems, or other individual electronic devices.

In general, the basic idea of the present invention is to provide a method for allowing automatic disclosure of at least one common interest between at least two entities while keeping non-common interests undisclosed or secret from other entities. In accordance with the present invention, one or more interests of a first entity are automatically revealed to one or more other entities in the case where those entities have matching interests, and vice versa, while non-matching interests are not disclosed or revealed to any entity. Further, unlike conventional schemes for disclosing or sharing common interests, such disclosure or non-disclosure of interests is accomplished in accordance with the present invention without the use of a third party, mediation, or trusted agent type application or process for comparing shared or common interests. Consequently, in accordance with the present invention, there is no database, application, process, etc. that is external to any entity to which the interests of that entity is disclosed or revealed for the purposes of determining whether any of the entities interests match those of any other entity.

In particular, interests are represented by a string of at least one bit that in one embodiment represents alphanumeric characters such as letters, numbers or other characters, or any other conventional encoding scheme including conventional encryption or plain text. In the most general case, any string of bits representing interests is compared against any other string of bits using the methods described below in order to determine whether the strings match. However, in one embodiment, bit strings represent interests from a predefined set of interests of any desired size.

Next, each interest is compared, one bit or character at a time, by disclosing one bit or character at a time for each interest. Then, in one embodiment, as soon as the comparison indicates that one bit or character of an interest of a first entity does not match any other interests of any other entity, the comparison is terminated with respect to the interest being compared. Consequently, where the comparison is terminated, the interest being compared is not completely disclosed. However, the comparison continues for as long as each bit or character continues to match one or more interests of another entity, with bits being disclosed only to those entities where there is a continuing partial match.

One example of determining whether separate entities have matched interests is embodied in buyer/seller relationship where the seller does not wish to disclose his or her entire inventory or prices for items in the inventory, and where the buyer is only interested in certain items within a certain price range. In this example, interests are considered to consist of an object/price pair. Consequently, the seller will specify a price or price range for each object in his inventory. This information, i.e., the seller's set of interests, is then stored in a seller accessible computer readable medium. Further, the buyer will likewise specify a price or price range for each object that he or she is interested in acquiring. Again, this information, i.e., the buyer's set of interests, is then stored in a buyer accessible computer readable medium. The seller's set of interests is then automatically compared to the buyer's set of interests using the turn-wise partial disclosure method described above to determine whether the buyer is interested in purchasing any object that the seller may have to sell at a price that the seller is willing to sell the object for.

In accordance with the present invention, the only interests of the buyer that will be disclosed to the seller are those interests that the buyer has that represent objects in the seller's inventory that the buyer is willing to buy for a price acceptable to the seller. Conversely, the only interests of the seller that are disclosed to the buyer are those objects in the seller's inventory that the seller is willing to sell for a price acceptable to the buyer. Further, the system and process of the present invention ensures that any objects, and their associated prices, in the seller's inventory that do not match the interests of the buyer are not disclosed to the buyer. Conversely, any objects being sought by the buyer, along with the price that the buyer is willing to pay that do not match the seller's interests are not disclosed to the seller.

Clearly, with respect to the buyer/seller example described above, the system and process of the present invention is useful for directing targeted advertising to consumers who are likely to purchase specific products. Further, in a networked environment such as the Internet, such targeted advertising can be automatically provided to a consumer or user via a conventional web browser application. Additionally, such a system and process is also useful for directing consumers to specific vendors. For example, in a networked environment such as the Internet, a conventional web browser can be automatically directed to the web sites of one or more vendors offering products that a consumer or user has an interest in purchasing without disclosing the consumers interests. Clearly, it should be appreciated by those skilled in the art that such a model could easily be expanded to include automatically “pushing” any information of interest to a user via a conventional web browser, or “pulling” the user to one or more web sites having any information of interest to the user. Further, in accordance with the present invention, such pushing or pulling of information is accomplished without disclosing the interests of any entity to any other entity not having shared interests, or nearly shared interests.

Other examples of useful applications of the present invention include on-line or Internet based marketplaces or auctions. For example, in one embodiment using a system and method according to the present invention, on-line vendors of goods or services are automatically matched with consumers having an interest in the goods or services offered by the vendors. Similarly, in a related embodiment users are automatically matched with goods or services available in an on-line auction where the user has an interest in such goods or services, and/or the user is willing to pay a price within a predetermined range of the current auction price for the goods or services. In a further related embodiment, such matching allows for automatic bidding for auctioned goods or services within a predetermined price range specified by the user. In each of these embodiments, non-matching interests or price ranges are not disclosed in accordance with the present invention.

In a further embodiment, a set of possible interests is classified hierarchically, such that approximate matches can be identified. For example, in cases where interests are classified hierarchically, approximate matches or nearly shared interests are identified. Such approximate matches are then disclosed to the entities where the matches are sufficiently close. For example, given a hierarchical set of interests including religion, with known religions provided in multiple layers of sub-categories, a Lutheran and Episcopalian share the fact that they are both Christian. Thus, where Christianity is a sufficiently close match in accordance with a predefined closeness metric, the matched interest of Christianity is disclosed, but the specific religious beliefs of each entity are not disclosed because they do not match.

Further, in one embodiment, the specific interest of each entity is disclosed where they are deemed to be close enough in accordance with the predefined closeness metric. Thus, to expand the preceding example, one exemplary closeness metric for the interest of religion assumes that a Lutheran is closer to an Episcopalian than to a Baptist, yet further from a Moslem; however, a Lutheran is closer to a Moslem than to an Atheist in that the Lutheran and the Moslem both believe in a God, while the Atheist does not. Consequently, one use of such a closeness metric would be to disclose a belief in a God without disclosing a specific religion to each entity where a first entity is a Lutheran, and a second entity is a Moslem. Further, where a third entity is an Atheist, nothing would be disclosed to the Atheist, as the third entity does not share the belief in God commonly held by the first and second entities.

Thus, expanding upon this simple example of religion, in one embodiment, using a hierarchical set of interests comprising interest categories having at least one sub-level of interests or sub-categories, the closest matched category or interest is disclosed. Further, such a method also allows for disclosure of exact matches. Clearly, in accordance with the present invention, those skilled in the art will appreciate that any interest, having any number of sub-interests or sub-categories can be implemented in a hierarchical structure.

One simple example of another hierarchical interest set is an interest in sports, with sub-categories of team sports and individual sports. Further, the sub-category of team sports may include sub-sub-categories of baseball, football, and soccer, while the sub-category of individual sports may include sub-sub-categories of swimming, running, tennis, and rock climbing. Consequently, using this simple hierarchical interest structure, the broadest match between two entities would simply be an interest in sports, with narrower matches being shared interests in team or individual sports, and the narrowest matched interest being a shared interest in one of the specific sports listed above.

In addition to the just described benefits, other advantages of the present invention will become apparent from the detailed description which follows hereinafter when taken in conjunction with the accompanying drawing figures.

### BRIEF DESCRIPTION OF DRAWINGS

The specific features, aspects, and advantages of the present invention will become better understood with regard to the following description, appended claims, and accompanying drawings where:

FIG. 1 is a diagram depicting a general-purpose computing device constituting an exemplary system for implementing the present invention.

FIG. 2 illustrates an exemplary architectural flow diagram for implementing the present invention.

FIG. 3 is an exemplary flow diagram for implementing a working example of the present invention.

### DETAILED DESCRIPTION

In the following description of the preferred embodiments of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

Exemplary Operating Environment:

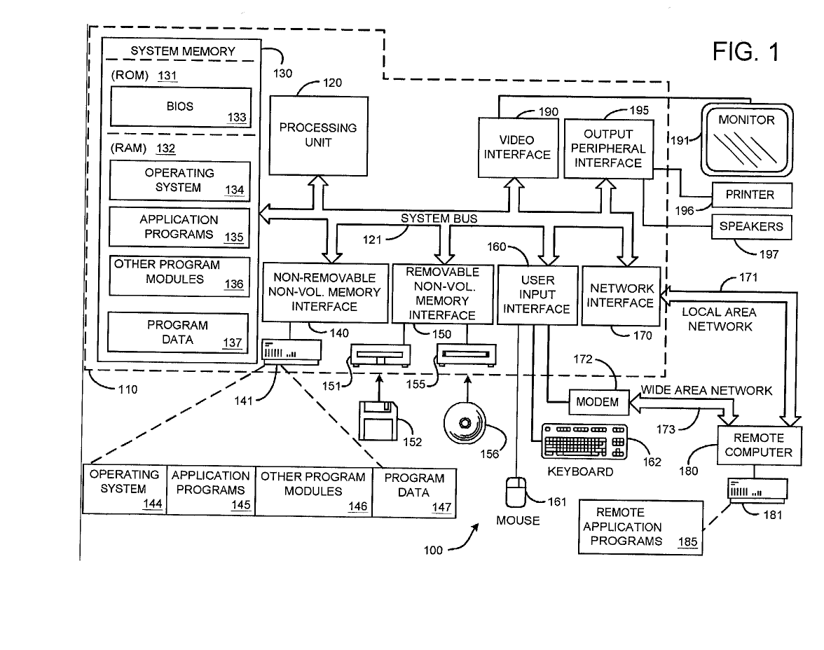

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held, laptop or mobile devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. With reference to FIG. 1, an exemplary system for implementing the invention includes a general purpose computing device in the form of a computer 110.

Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The exemplary operating environment having now been discussed, the remaining part of this description will be devoted to a discussion of the program modules and processes embodying the present invention.

System Overview:

The present invention involves a new system and process for automatically allowing at least two entities to disclose shared or common interests without disclosing non-shared interests. The present invention solves the aforementioned problems, as well as other problems that will become apparent from an understanding of the following description by automatically determining matched interests between two or more entities and disclosing those matches without disclosing non-matched interests. Further, such matching is accomplished without the use of an intermediary application, scheme, or process in order to avoid the disclosure of the interests of any entity to a third party. Specifically, interests are matched by automatically progressively comparing the interests of each entity. In accordance with the present invention, the term “entity” is defined to mean individual users, individual computer systems, or other individual electronic devices.

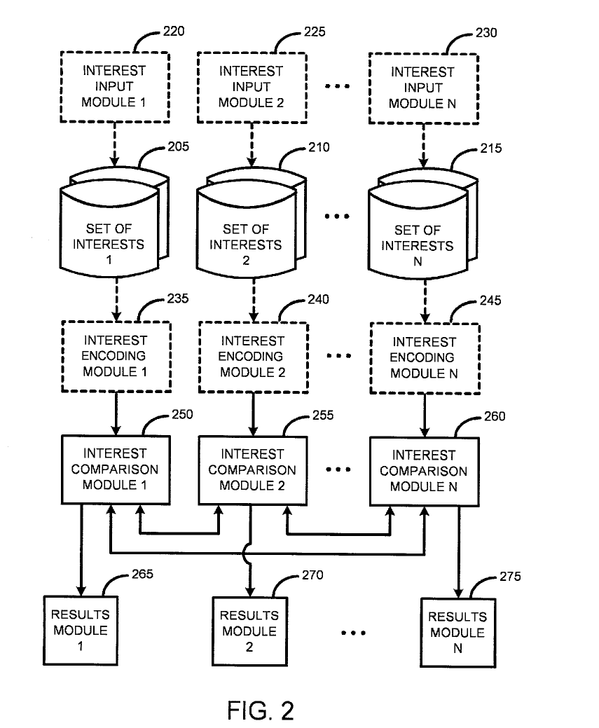

FIG. 2 is a general system diagram illustrating program modules for implementing the present invention. It should be noted that the boxes and interconnections between boxes that are represented by broken or dashed lines in FIG. 2 represent alternate embodiments of the present invention, and that any or all of these alternate embodiments, as described below, may be used in combination.

In general, the basic idea of the present invention is to provide a method for allowing automatic disclosure of at least one common interest between at least two entities while keeping non-common interests undisclosed or secret from other entities. In accordance with the present invention, one or more interests of a first entity are automatically revealed to one or more other entities in the case where those entities have matching interests, and vice versa, while non-matching interests are not disclosed or revealed to any entity. Further, unlike conventional schemes for disclosing or sharing common interests, such disclosure or non-disclosure of interests is accomplished in accordance with the present invention without the use of a third party, mediation, or trusted agent type application or process for comparing shared or common interests. Consequently, in accordance with the present invention, there is no database, application, process, etc. that is external to any entity to which the interests of that entity is disclosed or revealed for the purposes of determining whether any of the entities interests match those of any other entity.

In particular, with reference to FIG. 2, each entity has a set of interests 205, 210 and 215, respectively, stored in a computer readable medium such as an electronic list or database, with each entities interest set preferably accessible only to that entity. These sets of interests, 205, 210 and 215, are preferably compiled using conventional techniques, such as by user selection of interests from a list of interests, or user entry of any desired characters, words, phrases, numbers, etc. for representing interests. In one embodiment, user selection or entry of interests is accomplished via an interest input module, 220, 225 and 230, which uses conventional data entry techniques for selecting interests from a predefined list or simply entering any desired interest. Further, in one embodiment, a set of interests for each entity is automatically generated using any of a number of conventional probabilistic models for predicting user interests.

The interests in each set of interests, 205, 210 and 215, are represented by a string of at least one bit or character. Such characters include, for example, alphanumeric characters, such as letters, numbers or any other characters. Further, in one embodiment, the interests are encoded using an interest encoding module, 235, 240, and 245. Such encoding can be any conventional encoding scheme. However, in one embodiment, the encoding scheme uses a conventional one-way hash, as described herein, to prevent a determination of any interests from partially disclosed interests. In a preferred embodiment, it is assumed that a hash sequence used for encoding interests is known to all entities exchanging shared interests for any given interest exchange session. Further, it is assumed that each of these entities uses the known hash sequence for that interest exchange session. In a related embodiment, new or different hash sequences are used for each interest exchange session. Such hash sequences are determined using conventional encryption techniques.

In the most general case, any string of bits representing interests is compared against any other string of bits using the methods described below in order to determine whether the strings match. However, in one embodiment, bit strings represent interests from a predefined set of interests of any desired size. This comparison is accomplished by an interest comparison module, 250, 255, and 260. These interest comparison modules, 250, 255, and 260, compare each interest against the interests in every other set of interests. In the most general case, the interest comparison modules, 250, 255, and 260, compare a sequence of one-way hashes or partial one-way hashes of the interests. In alternate embodiments, either the entire hashes, portions of the hashes, or individual characters or bits of the hashes are compared. For example, in the case where individual characters or bits are compared, such bits or characters are compared by disclosing one bit or character at a time for each interest.

In one embodiment, as soon as the comparison indicates that the hashed interest of a first entity does not match any other hashed interest of any other entity, the comparison is terminated with respect to the hashed interest being compared. For example, in the case of single bit or character comparisons, as soon as one bit or character of an interest of a first entity does not match any other interests of any other entity, the comparison is terminated with respect to the interest being compared. Consequently, where the comparison is terminated, the interest being compared is not completely disclosed. However, the comparison continues for as long as each hashed interest, or each bit or character continues to partially match one or more interests of another entity, with hashes, partial hashes bits, or characters being disclosed only to those entities where there is a continuing partial match. Further, in one embodiment, as described in further detail below, a closeness metric is used to determine whether interests are close enough. Finally, matched interests, and in one embodiment, close interests are disclosed to each entity via a results module, 265, 270 and 275 which uses a conventional display or output device to indicate exact or close matches.

In a further embodiment, a communications channel between the entities engaged in comparing interests is itself encrypted using conventional techniques for encrypting communications between two or more entities, such as for example by using a conventional public/private key system for encryption and decryption. Thus, as the interests are compared as described above, each interest hash or each bit or character of the interest or hashed interest is itself encrypted when transmitted from one entity to another, then decrypted for comparison. It should be noted that where the communications channel is encrypted, any encryption of the transmitted information is separate from the encryption or hashing described above for each interest. Consequently, in this embodiment, the transmitted hash, or the transmitted bits or characters decrypted for comparison are actually still encrypted if those interests were encrypted or hashed as described above. Encryption of the communications channel or pipe provides a further level of security, and is useful for preventing unauthorized third parties from acquiring useful information about the interests of any other entities.

One example of determining whether separate entities have matched interests is embodied in buyer/seller relationship where the seller does not wish to disclose his or her entire inventory or prices for items in the inventory, and where the buyer is only interested in certain items within a certain price range. In this example, interests are considered to consist of an object/price pair. Consequently, the seller will specify a price or price range for each object in his inventory. This information, i.e., the seller's set of interests, is then stored in a seller accessible computer readable medium. Further, the buyer will likewise specify a price or price range for each object that he or she is interested in acquiring. Again, this information, i.e., the buyer's set of interests, is then stored in a buyer accessible computer readable medium. The seller's set of interests is then automatically compared to the buyer's set of interests using the turn-wise partial disclosure method described above to determine whether the buyer is interested in purchasing any object that the seller may have to sell at a price that the seller is willing to sell the object for.

In accordance with the present invention, the only interests of the buyer that will be disclosed to the seller are those interests that the buyer has that represent objects in the seller's inventory that the buyer is willing to buy for a price acceptable to the seller. Conversely, the only interests of the seller that are disclosed to the buyer are those objects in the seller's inventory that the seller is willing to sell for a price acceptable to the buyer. Further, the system and process of the present invention ensures that any objects, and their associated prices, in the seller's inventory that do not match the interests of the buyer are not disclosed to the buyer. Conversely, any objects being sought by the buyer, along with the price that the buyer is willing to pay that do not match the seller's interests are not disclosed to the seller.

Clearly, with respect to the buyer/seller example described above, the system and process of the present invention is useful for directing targeted advertising to consumers who are likely to purchase specific products. Further, in a networked environment such as the Internet, such targeted advertising can be automatically provided to a consumer or user via a conventional web browser application. Additionally, such a system and process is also useful for directing consumers to specific vendors. For example, in a networked environment such as the Internet, a conventional web browser can be automatically directed to the web sites of one or more vendors offering products that a consumer or user has an interest in purchasing without disclosing the consumers interests. Clearly, it should be appreciated by those skilled in the art that such a model could easily be expanded to include automatically “pushing” any information of interest to a user via a conventional web browser, or “pulling” the user to one or more web sites having any information of interest to the user. Further, in accordance with the present invention, such pushing or pulling of information is accomplished without disclosing the interests of any entity to any other entity not having shared interests, or nearly shared interests.

Other examples of useful applications of the present invention include on-line or Internet based marketplaces or auctions. For example, in one embodiment using a system and method according to the present invention, on-line vendors of goods or services are automatically matched with consumers having an interest in the goods or services offered by the vendors. Similarly, in a related embodiment users are automatically matched with goods or services available in an on-line auction where the user has an interest in such goods or services, and/or the user is willing to pay a price within a predetermined range of the current auction price for the goods or services. In a further related embodiment, such matching allows for automatic bidding for auctioned goods or services within a predetermined price range specified by the user. In each of these embodiments, non-matching interests or price ranges are not disclosed in accordance with the present invention.

In a further embodiment, a set of possible interests is classified hierarchically, such that approximate matches can be identified. For example, in cases where interests are classified hierarchically, such as for example, by using a conventional tree structure, approximate matches or nearly shared interests are identified based on whether such interests share a common branch point that is within any desired distance from the specific interests. Such approximate matches are then disclosed to the entities where the matches are sufficiently close. For example, given a hierarchical set of interests including religion, with known religions provided in multiple layers of sub-categories, a Lutheran and Episcopalian share the fact that they are both Christian. Thus, where Christianity is a sufficiently close match in accordance with a predefined closeness metric, the matched interest of Christianity is disclosed, but the specific religious beliefs of each entity are not disclosed because they do not match.

Further, in one embodiment, a generic interest of each entity is disclosed where the interests are deemed to be close enough in accordance with the predefined closeness metric. Thus, to expand the preceding example, one exemplary closeness metric for the interest of religion assumes that a Lutheran is closer to an Episcopalian than to a Baptist, yet further from a Moslem; however, a Lutheran is closer to a Moslem than to an Atheist in that the Lutheran and the Moslem both believe in a God, while the Atheist does not. Consequently, one use of such a closeness metric would be to disclose a belief in a God between a first entity and a second entity without disclosing a specific religion to each entity where the first entity is a Lutheran, and the second entity is a Moslem. Again, such a scheme can easily be implemented using any of a number of conventional hierarchical structures, such as a tree structure, with the common branch point for the first and second entity being an interest in God. Thus, where a third entity is an Atheist, nothing would be disclosed to the Atheist as the third entity does not share the belief in God commonly held by the first and second entities.

Thus, in accordance with the simple example provided above, in a generic embodiment of the present invention, a hierarchical set of interests comprising interest categories having at least one sub-level of interests or sub-categories, is used to identify and disclose the closest matched category or interest between at least two entities. Further, such a method also allows for disclosure of exact matches. Clearly, in accordance with the present invention, those skilled in the art will appreciate that any interest, having any number of sub-interests or sub-categories can be implemented in a hierarchical structure.

One simple example of another hierarchical interest set is an interest in sports, with sub-categories of team sports and individual sports. Further, the sub-category of team sports may include sub-sub-categories of baseball, football, and soccer, while the sub-category of individual sports may include sub-sub-categories of swimming, running, tennis, and rock climbing. Consequently, using this simple hierarchical interest structure, the broadest match between two entities would simply be an interest in sports, with narrower matches being shared interests in team or individual sports, and the narrowest matched interest being a shared interest in one of the specific sports listed above.

Further, where there are more than two entities, different levels, categories, or sub-categories of interests may be disclosed to each entity. For example, assume the existence of three entities, with the first entity having an interest in baseball, the second entity having an interest in swimming, and the third entity also having an interest in swimming. In accordance with the present invention, the disclosure between the first entity and the second entity would be an interest in sports, as sports is the closest match. Similarly, the disclosure between the first entity and the third entity would also be an interest in sports, as the interest in sports is again the closest match. Finally, the disclosure between the second entity and the third entity would be an interest in swimming, as both the second and third entities have an interest in swimming.

Operation:

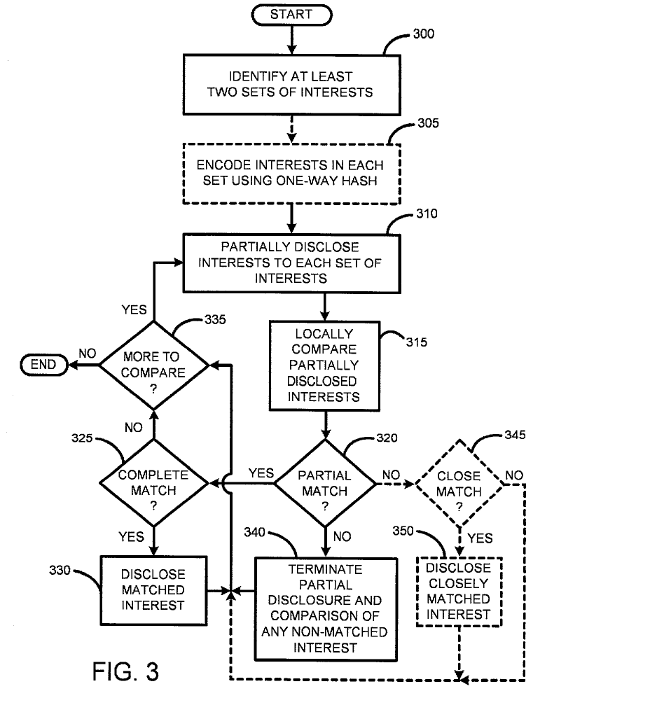

The above-described program modules are employed to automatically disclose shared or common interests without disclosing non-shared interests using the exemplary process that will now be described. This process is depicted in the flow diagram of FIG. 3. It should be noted that the boxes and interconnections between boxes that are represented by broken or dashed lines in FIG. 3 represent alternate embodiments of the present invention, and that any or all of these alternate embodiments, as described below, may be used in combination.

Referring now to FIG. 3 in combination with FIG. 2, the process is started by identifying at least two sets of interests (Box 300) belonging to unique entities. As described above, with reference to FIG. 2, these sets of interests are compiled using conventional data entry methods. Once these interests have been identified (Box 300), in one embodiment, they are encoded using a conventional one-way hash (Box 305) to prevent a determination of any interests from partially disclosed interests.

Whether or not the interests have been encoded, a string representing each interest is disclosed to the other entities, for comparison with those entities interest sets, (Box 310) as described above. A local comparison is then made of the disclosed information (Box 315). In other words, the interest comparison module of each entity, as described above with reference to FIG. 2, compares the disclosed interest, hashed interest, partial hash, bit or character of the interest or hashed interest with the corresponding interest, hashed interest, partial hash, bit or character of the interest or hashed interest of each of the interests of those entities. If a partial match is identified (Box 320), i.e., the disclosed interest, hashed interest, partial hash, bit or character of the interest or hashed interest partially matches an interest, hashed interest, partial hash, bit or character of an interest or hashed interest of one of the other entities, a determination is then made as to whether a complete match has been identified (Box 325).

For example, in a trivial case, if the interest is represented by a single bit or character, where the first disclosed bit matches that of any other entities interests, a complete match would exist. If a complete match exists, the matching interest is disclosed to those entities having a matched interest (Box 330). At this point, if there are more interests to compare (Box 335), the partial disclosure and comparison of interests (Box 310 and Box 315) continues as described herein. However, if there are no more interests, hashed interests, bits, characters, or partial hashes to compare, the process is ended.

However, where the interest is represented by more than one bit or character, a complete match is not indicated by simply matching a single bit or character. Consequently, if there are more bits, characters, or partial hashes of the interest left to compare (Box 335), the next bit, character, or partial hash of the interest is disclosed (Box 310) and compared (Box 315) as described above.

In the event that a partial match is not identified (Box 320), the partial disclosure and comparison of the interest not having a partial match is immediately terminated (Box 340) to prevent further disclosure of the non-matched interest. At this point, if there are more interests, bits, characters, or partial hashes to compare (Box 335), the partial disclosure and comparison of interests (Box 310 and Box 315) continues as described herein. However, if there are no more interests, bits, characters, or partial hashes to compare, the process is ended.

Further, in one embodiment, if a partial match is not identified (Box 320), a determination is made as to whether a close match can be identified (Box 345). A determination of whether interests are closely matched is accomplished using a closeness metric as described above. If a close match exists, the closely matching interest is disclosed to those entities having a closely matched interest (Box 350). At this point, if there are more interests, bits, characters, or partial hashes to compare (Box 335), the partial disclosure and comparison of interests (Box 310 and Box 315) continues as described herein. However, if there are no more interests, bits, characters, or partial hashes to compare, the process is ended.

Working Example:

In a simple working example the present invention, an encoding scheme, Gⁱ, as described below, is used to encode the interests of at least two entities, i.e., entity A and entity B, such that matching interests of entity A and entity B are revealed progressively upon partial matches. In accordance with the preceding discussion, Gⁱ can be any conventional scheme for hashing or encoding the interests of each entity. Specifically, any Gⁱ that satisfies the constraints of Equations 1, 2 and 3 as illustrated and described below can be used for hashing or encoding the interests. Such encoding schemes include, for example, using prime numbers, or multiples of prime numbers for encoding interests, and again, any conventional encoding scheme may be used. Further, as described above, the encoding scheme may also include a one-way hash.

Assuming that the interests are encoded, given at least two entities A and B, for purposes of explanation it is assumed that that entity A and entity B have interests that they wish to compare: {a₁, a₂, . . . , aₙ} and {b₁, b₂, . . . , bₙ}, respectively, where the complete set of interests is {c₁, c₂, . . . , c_{M}} However, it should be noted that in one embodiment, there is no requirement for entity A and entity B to have the same number of interests. Further, in one embodiment, in order to reduce the likelihood of disclosing non-shared interests, the total number of possible interests, M, is much larger than the set of interests for either entity A or entity B, (i.e. M>>n).

Further, {Gⁱ} is defined as a set of cumulative non-overlapping multivalent one-way encodings for the interests of entity A and entity B. Thus, for any Gⁱ:

a=b [symbol] =Gⁱ(a)=Gⁱ(b) Eqn. 1

It should be noted here that in accordance with Equation 1, where interest a is equivalent to interest b, i.e., a=b, then Gⁱ(a)=Gⁱ(b), however, because the encodings are one way, Gⁱ(a)=Gⁱ(b) does not imply that a=b. Specifically, there should be distinct elements c and d (i.e. c≠d) such that Gⁱ(c)=Gⁱ(d) Such one-way encodings prevent decoding of coded interests in order to determine what those interests are if they are not disclosed. Specifically as illustrated by Equation 2, only where Gⁱ(a)=Gⁱ(b) for all values of i, then and only then does a=b, and vice versa:

Gⁱ(a)=Gⁱ(b)∀i [symbol] a=b Eqn. 2

Thus, in accordance with Equation 2, where Gⁱ(a)=Gⁱ(b) for all values of i, interest a of entity A matches interest b of entity B.

The basic premise illustrated by Equations 1 and 2 is used to create an exemplary turn-based system for progressively disclosing individual interests in such a manner as to avoid complete disclosure of such interests unless there is a full match. Specifically, in order to ensure honesty, entity A and entity B take turns disclosing hashes. However, in one embodiment, either entity A or entity B always progressively discloses interests before the other entity makes a disclosure. In other words, entity A and entity B share {G¹(aᵢ)} and {G¹(bᵢ)}. For example, assuming that entity A and entity B takes turns in progressively disclosing interests, in Turn 1, A declares G¹(a₁) then B declares G¹(b₁); in Turn 2, B declares G²(b₂) then A declares G²(a₂); in Turn 3, A declares G³(a₃), then B declares G³(b₃); etc. Then, for example, if G¹(aₖ)=G¹(bⱼ), and G¹(aₘ)=G¹(bₙ), then there is a chance that either or both a_{k,} bⱼ and a_{m,} bₙ are matched interests. Therefore, these elements are next hashed with G². If this hashing indicates that G²(aₖ)=G²(bⱼ), then it is clear that aₖ may equal bⱼ, and at least a partial match is indicated for these interests. Similarly, if this hashing indicates that G²(aₘ)≠G²(bₙ), then it is clear that aₘ≠bⱼ, and thus there is no match for these interests.

Further, it should be noted that in accordance with Equation 3, if M is the number of items in the universe of interest, s the number of encoding steps and Dⱼ is the number of different values encoding G^{j} can take at step j, then there is a requirement that:

$${\prod }_{j = 1}^{s} {D}_{j} \geq M \qquad Eqn . 3$$

In implementing an exemplary working example using the aforementioned encoding scheme for entity A and entity B, a set of interests for each entity is selected from a set of all possible interests, which in this case is assumed to include 1000 interests, with each interest being assigned a number from 0 to 999. Clearly, a set consisting of any number of possible interests can be used. Thus, assuming 1000 possible interests, M=1000 given that there are 1000 possible unique interests numbered from 0 to 999. Given this framework, it is assumed that the interest set of entity A={521, 739, 002, 178, 991} and that the interest set of entity B={839, 178, 251, 023, 426}.

Therefore, in determining whether entity A and entity B have any matched interests, a sequential comparison of the digits representing the interests is made starting with the least significant digit. As described above, it should be appreciated by those skilled in the art that there are many ways in which to encode the interests, other than simply numbering the interests or selecting particular coefficients of such numbers for comparisons. Further, with respect to this example, there is no requirement that the least significant digit be compared first, and in fact, in this example, starting with the most significant digit and progressing to the least significant digit works equally well. Given a comparison of digits in base-10 numbers, then:

ΠDⱼ=10×10×10=M=1000

and thus, in accordance with Equation 3, s=3; Dⱼ=10 for j=0, 1, 2. Therefore, using these parameters, for example, assuming a₁ is equal to 537, then Gⁱ(a₁) is equal to the value of the coefficient of 10ⁱ in a, e.g. G⁰(537)=7; G¹(537)=3; G²(537)=5.

Consequently, in the first turn, i.e. “Round 1” the interests of entity A and entity B are encoded with G⁰, and entity A and entity B declare their least significant digits for all of their interests in an attempt to determine whether there is at least a partial match for any of the interests. Thus, for Round 1, since the interests of entity A are 521, 739, 002, 178, and 991, and those of entity B are 839, 178, 251, 023, and 426, entity A declares “1, 2, 8, and 9” and entity B declares “1, 3, 6, 8, and 9.” An automatic comparison of the declared numbers indicate that several of the least significant encoded numbers match in Round 1; i.e. 1, 8 and 9. Therefore, the interests associated with these numbers of both entity A and entity B go on to Round 2, while any interests that do not have a partial match are removed from consideration since there is no possibility of a complete match.

In Round 2, the partially matched interests are encoded with G¹, and thus both entity A and entity. B declare the next significant digit for each of the partially matched interests. Specifically, in Round 2, since the partially matched interests of entity A having a least significant number of “1” are 521 and 991, and those of entity B are 251, A declares “2” and “9”, and B declares “5”. Clearly there are no matches here, so each the associated interests are removed from further consideration. With respect to the interests having a least significant number of “8,” entity A has interest 178, and entity B has interest 178. Thus, entity A and entity B both declare “7.” Thus, these interests represent a partial match that will be further evaluated in Round 3. With respect to the interests having a least significant number of “9,” entity A has interest 739, and entity B has interest 839. Thus, entity A and entity B both declare “3.” Thus, these interests represent a partial match that will be further evaluated in Round 3.

In Round 3, the partially matched interests from Round 2 are encoded with G² and thus both entity A and entity B declare the next significant digit for each of the partially matched interests. Specifically, in Round 3, the partially matched interests of entity A and entity B are further automatically compared. Thus, given the partial matches found in Round 2, i.e. 7 and 3 in the second position, entity A has 178 and 739, while entity B has 178 and 839. Thus, with respect to the partially matched interests ending with “78,” entity A and entity B both declare a “1” for the most significant number. This declaration results in complete match for interest 178. Further, respect to the partially matched interests ending with “39,” entity A declares a “7,” while entity B declares an “8.” Clearly, this declaration does not result in a match.

It should be noted that using this simple encoding scheme described above, entity A and entity B disclosed shared interest 178. Further, entity A disclosed non-shared interest 739 to entity B while entity B disclosed non-shared interest 839 to entity A. Clearly, more complicated encoding schemes using a larger numbers can be used to ensure that it becomes very unlikely that non-shared interests are disclosed, or that it is highly unlikely that any non-shared interests are disclosed. For example, an encoding scheme that has decreasing numbers of possible values at each successive step is less likely to disclose non-matches or non-shared interests. Further, such a scheme is also more efficient since the larger number of hash values compared in early rounds removes non-matched interests quickly. In the example, the Dⱼ were 10, 10, 10. There were in principle 9 possible non-matching items in the last step, one for every possible value, though the example only contained one.

Specifically, using the above example, a hash with, for example, Dⱼ's of 100, 5 and 2 still satisfies the condition of Equation 3, i.e.:

ΠDⱼ≧1000

However, since there are only 2 possible values in the last hash (i.e. Round 3), there would be at most one disclosed non-matching number. Thus, while in the aforementioned working example there was a 9 in 1000 chance of a non-shared interest being disclosed, in this second case there is only 1 in 1000 chance of a non-shared interest being disclosed. Clearly, in accordance with the foregoing discussion, a sufficiently large M, with appropriate Dⱼ's can be chosen such that it would be statistically improbable that any non-shared interests could be ever disclosed.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system for determining shared interests between at least two sets of interests, comprising:
progressively comparing each interest in each set of interests to interests in every other set of interests;
analyzing the results of the progressive comparison for determining whether any interests belonging to any set of interests partially matches any interests in any other set of interests;
terminating the progressive comparison for specific interests with respect to each set of interests wherein the specific interests do not partially match any interests; continuing the progressive comparison for specific interests with respect to each set of interests wherein the specific interests do partially match any interests; and
determining all shared interests between any of the at least two sets of interests by continuing the progressive comparison of interests to identify all interests belonging any set of interests that completely match interests in any other set of interests.

2. The system of claim 1 wherein each set of interests is encoded using a one-way hash for preventing an identification of partially matched encoded interests.

3. The system of claim 1 wherein each interest in each set of interests is encrypted.

4. The system of claim 1 wherein each set of interests is identified by unique users.

5. The system of claim 1 wherein each set of interests is identified by unique users from a list of predefined interests.

6. The system of claim 1 further comprising determining whether specific interests are closely matched with any interests in any other set of interests after terminating the progressive comparison for specific interests which do not partially match any interests.

7. The system of claim 6 wherein interests are categorized in a hierarchical structure in order to facilitate the determination as to whether the specific interests are closely matched with any interests in any other set of interests.

8. The system of claim 1 wherein all shared interests are disclosed between sets of interests having the shared interests.

9. The system of claim 1 wherein progressively comparing each interest further comprises progressively transmitting each interest via at least one encrypted communications channel.

10. A computer-implemented process for automatically determining whether unique entities have any matched interests without disclosing non-matched interests, comprising:
providing a set of interests for each entity;
encoding each interest for each set of interests;
partially disclosing each encoded interest in each set of interests to each unique entity;
automatically performing a comparison of each partially disclosed encoded interest with the partially disclosed interests in each other set of interests;
determining whether there is a partial match of interests between the partially disclosed interests of any unique entities;
continuing to automatically perform the partial comparison of each encoded interest for specific interests for as long as there is a partial match of the specific interests between any unique entities; and
automatically identifying interest matches between any unique entities through the continued automatic partial comparison of each encoded interest.

11. The computer-implemented process of claim 10 wherein encoding each interest comprises encoding each interest using a one-way hash.

12. The computer-implemented process of claim 10 wherein automatically identifying interest matches between any unique entities comprises identifying complete interest matches.

13. The computer-implemented process of claim 10 wherein automatically identifying interest matches between any unique entities comprises identifying close interest matches.

14. The computer-implemented process of claim 10 wherein partially disclosing each encoded interest in each set of interests to each unique entity comprises transmitting each partially discloses interest via at least one encrypted communications channel.

15. The computer-implemented process of claim 10 wherein encoding each interest for each set of interests comprises using a common encoding scheme for each set of interests.

16. The computer-implemented process of claim 15 wherein a new common encoding scheme is used each time new sets of interests are compared.

17. A computer-readable medium having computer executable instructions for identifying common interests between at least two entities without using a third party, said computer executable instructions comprising:
partially revealing each interest of each entity to each other entity;
determining whether any of the partially revealed interests match any other partially revealed interests by comparing the partially revealed interests;
continuing to partially reveal more of each partially matched interest of each entity to each other entity having a corresponding partially matched interest;
continuing to compare the partially matched interests; and
automatically determining whether the partially matched interests are common interests.

18. The computer-readable medium of claim 17 wherein the common interests are exactly matched interests.

19. The computer-readable medium of claim 17 wherein the common interests are closely matched interests.

20. The computer-readable medium of claim 19 wherein a set of all possible interests is categorized in a hierarchical structure in order to determine whether the common interests are closely matched interests.

21. The computer-readable medium of claim 17 wherein each interest is encoded prior to partially revealing each interest of each entity to each other entity.

22. The computer-readable medium of claim 17 wherein each interest of each entity is partially revealed to each other entity via a secure communications channel.

23. The computer-readable medium of claim 22 wherein the secure communications channel is an encrypted communication channel.
